(19) United States
(12) Patent Application Publication
(10) Pub. No.: US 2017/0326763 A1
(43) Pub. Date: Nov. 16, 2017

(54) METHOD FOR OBTAINING A HEAT-INSULATING AND SOUND-ABSORBING COMPOSITE PRODUCT, CO-MOULDING EQUIPMENT AND PRODUCT SO OBTAINED

(71) Applicant: SAPA SRL SOCIETA UNIPERSONALE, Arpaia (BN) (IT)

(72) Inventor: Antonio AFFINITA, Arpaia (BN) (IT)

(21) Appl. No.: 15/534,892

(22) PCT Filed: Dec. 10, 2014
(86) PCT No.: PCT/IT2014/000325

§ 371 Date: Jun. 9, 2017

(51) Int. Cl. B29C 44/12; B29C 33/14; B29K 75/00; B29K 105/12

(52) U.S. Cl. CPC B29C 44/1219; B29C 33/14; B29K 2995/0002; B29K 2075/00; B29K 2995/0015; B29K 2105/128

(57) ABSTRACT

A method for obtaining a heat-insulating and sound-absorbing composite product consisting in a fibrous material (MF) and in a polymeric material (MP) comprises the steps of positioning the fibrous material (MF) in a mould (1) equipped with a cavity that is only partially filled in a central zone thereof, overlapping polymeric material (MP) to the fibrous material (MF), approaching a counter-mould (3) provide with a counter-cavity (4) to the mould (1), expanding of the polymeric material (MP) by chemical reaction, forming the composite positioned between mold (1) and counter-mould (3), removing the counter-mould (3) from the mould (1) and extracting a product. After the step of forming the polymeric material (MP) covers the fibrous material (MF) in the central zone of the cavity and fills a peripheral groove (7) of the cavity of the mold (1). Further, a moulding equipment and the product so obtained are described.

### TECHICAL FIELD

The present invention relates to a method for obtaining a heat-insulating and sound-absorbing composite product. Generally this composite product consists of a heat-insulating polymeric material and a sound-absorbing fibrous material. Further, a moulding equipment for embodying the method according to the invention and the product so obtained are described.

### BACKGROUND ART

US 2008/0264555 discloses a method of producing a component of sound-absorbing composite material for motor vehicles, including a polymeric heavy layer and a sound-absorbing layer that is porous or fibrous. The method provides steps for pressing a certain volume of heavy layer material in an open cavity of a press including a lower mould and an upper counter-mould, closing of the press to obtain the molding of the heavy layer, opening the press and arranging of fibrous material on the heavy layer to form the sound-absorbing layer and, then, partially welding of the two layers by closing the same press, or using another press. The method according to US 2008/0264555 requires two steps of pressing, the first one for the forming of the polymer layer, the second for the forming of the fibrous layer and their mutual welding.

WO 2013/052378 describes a co-molding process by compression comprising the steps of positioning a fibrous material, for example carbon fiber, impregnated with a thermoplastic resin in a mold, and positioning over said fibrous material of a formable co-moulding material. A counter-mould is approached to the mould, and they are compressed together. This international patent application describes also the possibility of pre-positioning on the mould one or more inserts to be connected with the fibrous material.

WO 2013/052378 also deals with the problem of defining areas of the fibrous material that are intended to not receive the formable co-molding material above them. A solution is given that provides the use of so-called active cores that are mounted in the mould or in the counter-mould, and moved by hydraulic, pneumatic, mechanical or electromechanical means. Each active core has a pressure surface or gripping surface that is shaped to be pressed on a not co-moulding surface, that is, that should not receive any co-moulding material so as to prevent that the co-molding formable material flows over the not co-moulding surface. It is also stated that, in the case of a plurality of active cores, these can be interconnected and moved simultaneously during the process of closing and opening of the mould by a single shift mechanism. It is understood, however, that the solution provided by WO 2013/052378 for the delimitation of the extension of the co-moulding material is considerably complex, since it requires the presence of moving parts and operable as desired.

### SUMMARY OF THE INVENTION

In this context, a technical task underlying the present invention is to overcome drawbacks of the prior art mentioned above.

In particular, an object of the present invention is to enable the co-moulding of two materials, the one being fibrous the other one polymeric, wherein the polymeric material covers only the desired portion of the fibrous material.

Further, one object of the invention is to prevent that the polymeric co-moulding material fits into unwanted areas of the fibrous material such as the one on which the fibrous material is supported.

Still another object of the invention is to carry out a co-moulding in a short time and with moulds and counter-moulds that are cheap and simple to make.

The technical task mentioned and the aims specified are substantially achieved by a method for obtaining a heat-insulating and sound-absorbing composite product as described in claim 1.

In a second aspect of the invention, a co-moulding equipment is provided for according to claims 2 and 3 and, in a third aspect, the product obtained is provided for according to claim 4.

### BRIEF DESCRIPTION OF DRAWINGS

Further features and advantages of the present invention will become more apparent from the indicative, and therefore non-limiting description of a preferred but not exclusive embodiment of a method for obtaining a heat-insulating and sound-absorbing composite product, a co-moulding equipment and the product obtained, as illustrated in the accompanying drawings in which:

FIGS. 1 to 5 are schematic cross-section views illustrating successive steps of the method for obtaining a heat-insulating and sound-absorbing composite product according to the invention; and

FIGS. 6 and 7 are a perspective view and a cross-section view, respectively, of the resulting product shown in FIG. 5, but in an inverted position as compared to that one.

### DESCRIPTION OF PREFERRED EMBODIMENTS OF THE INVENTION

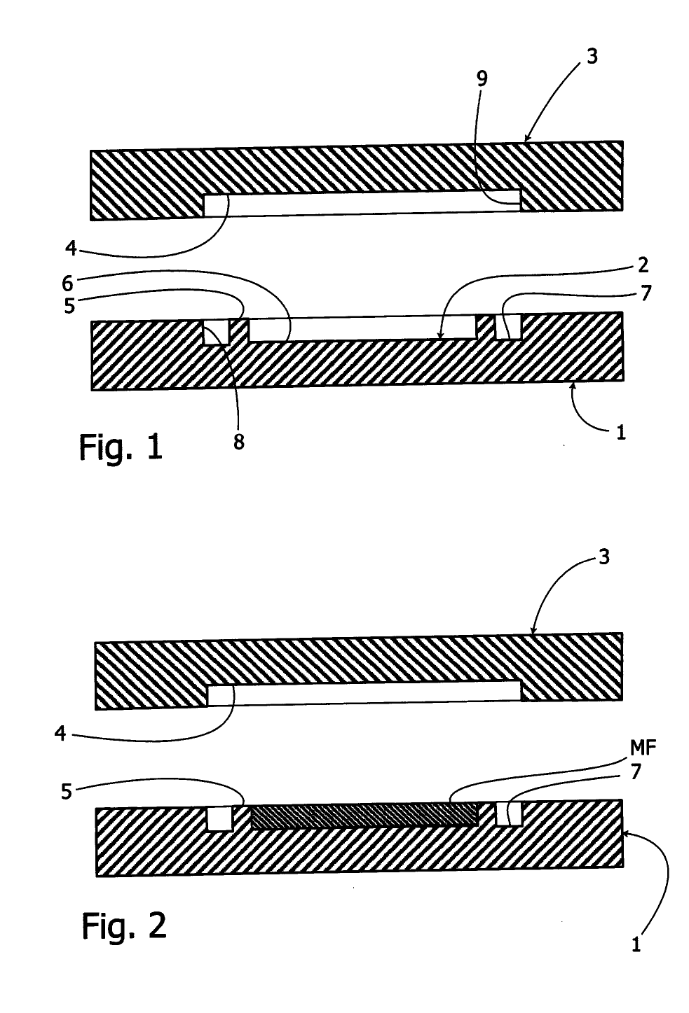

Referring initially to the schematic cross-section views of FIGS. 1 to 5, it can be noted that a co-moulding equipment comprising a mould 1 provided with a cavity 2, and a counter-mould 3 provided with a counter-cavity 4 is represented schematically in them. According to the invention, the cavity 2 in the mold 1 has a projection 5 which divides the cavity 2 in a central area 6 and in a peripheral groove 7.

The projection 5 is continuous and completely surrounds the central area 6 of the cavity 2.

The projection 5 has vertical walls so as to allow an easy delivery.

For manufacturing a product with a rectangular base, as shown in the perspective view and cross-section perspective view in FIGS. 6 and 7 with substantially rectangular mould and counter-mould cavities, the projection 5 has a square profile having walls that are opposite parallel and parallel to perimeter walls 8 of the cavity 2, respectively. The perimeter walls 8 of the cavity 2 are coplanar to walls 9 of the cavity 4 of the counter-mould 3, so that the counter-cavity 4 of the counter-mould 3 has a surface facing the cavity 2 in the mold 1 having an identical overall surface, i.e. disregarding the projection 5. It should be evident that, in presence of a different shape of the cavity, the projection will have a profile different from the squared one, but it should be such as to create in the mould cavity a peripheral groove with the perimeter walls of the cavity itself.

In the method according to the invention a fibrous material MF is first positioned in the cavity 2 of the mold 1 (FIG. 2). The fibrous material MF can be whatever one wants. In this embodiment, carbon fiber is chosen for its sound-absorbing properties. The cavity 2 in the mold lis filled only partially with the fibrous material MF, that is to say its central area 6, and the peripheral groove 7 of the same cavity 2 is kept empty.

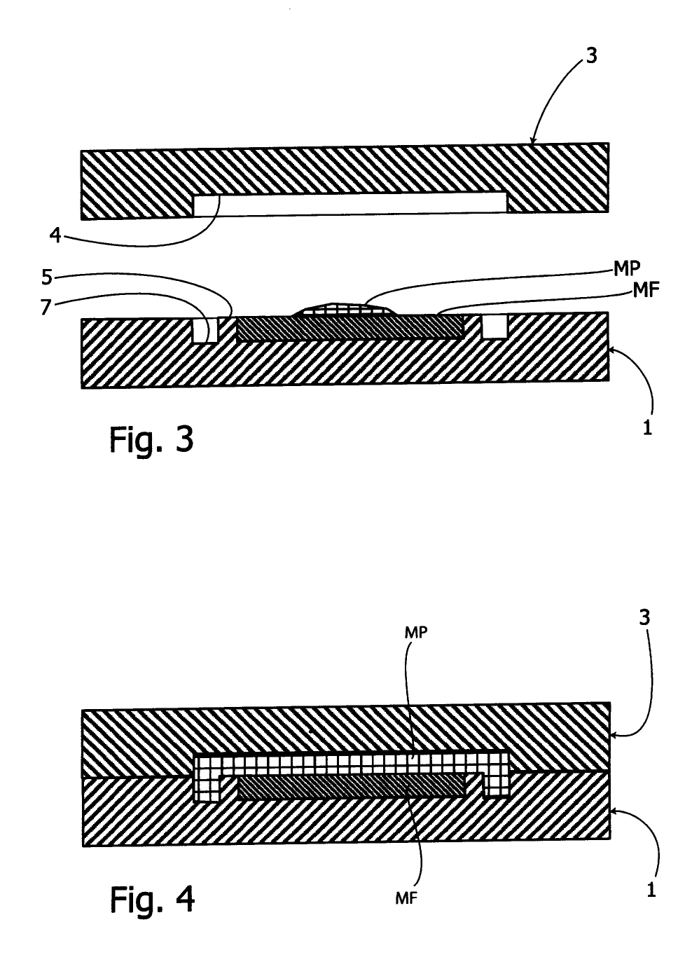

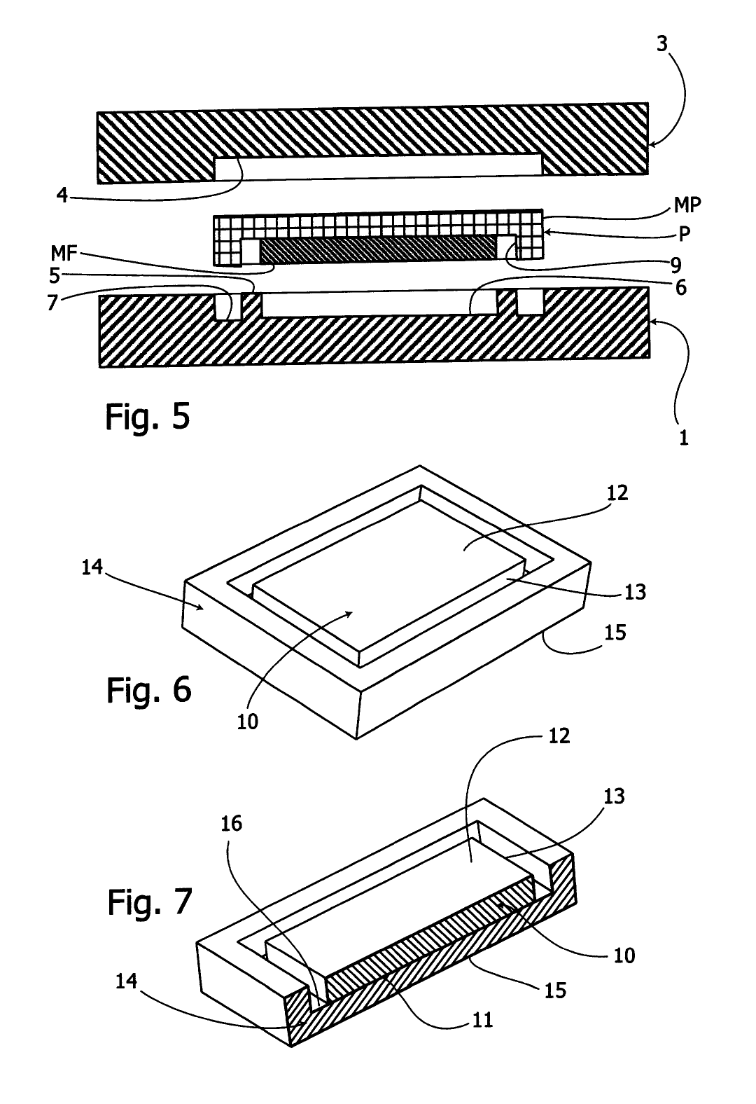

Then, with reference to FIG. 3, reaction substances are positioned on the fibrous material MF to obtain a polymeric material MP. The polymeric material may be polyurethane that expands due to the reaction between polyol and isocyanate. Then, as shown in FIG. 4, the counter-mould 3 is approached to the mould 1. The polymeric material MP grows in volume between mould 1 and counter-mold 3 so as to cover only the front of the fibrous material and to fill the peripheral groove 7 in the cavity 2 of the mould 1. Finally, as shown in FIG. 5, the counter-mould 3 is removed from the mould 1 and the product P as a heat-insulating and sound-absorbing composite product is extracted from the mould 1. The product P has a peripheral channel 9 obtained by the imprint left by the projection 5 of the mould 1. In FIGS. 6 and 7, the product P is shown upside down with respect to FIG. 5. As can be seen, the heat-insulating and sound-absorbing product P is made of composite of the two distinct fibrous MF and polymeric MP materials. The fibrous material MF form a first layer 10 having opposite bases 11 and 12, and side faces generally indicated at 13. The polymeric material forms a second layer 14 having a major base 15 and a minor base 16. The lower base 16 is overlapped and welded to the opposite base 11 of the first layer 10. The second layer 14 extends toward the side faces of the first layer 10 without being in contact with them due to the above mentioned peripheral channel 9.

In this way, the polymeric material of the second layer 14 is not poured onto the base 12 of the first layer 10 made of fibrous material as in the method of production the protrusion 5 prevents the expansion of the polymeric material during its chemical reaction.

The product P remains perfectly defined in its separate parts of fibrous material and polymeric material.

1. A method for obtaining a heat-insulating and sound-absorbing composite product consisting in a fibrous material (MF) and in a polymeric material (MP), the method comprising the steps of positioning the fibrous material (MF) in a mould (1) equipped with a cavity (2), overlapping the polymeric material (MP) to said fibrous material (MF), approaching a counter-mould (3) equipped with a counter-cavity (4) toward said mould (1), expanding the material polymer (MP) by chemical reaction, forming the composite positioned between mould (1) and counter-mould (3), removing the counter-mould (3) from the mould (1) and extracting the product, characterized in that:
in the step of positioning the fibrous material (MF) in the mould (1), the cavity (2) of the mould (1) is only partially filled in a central zone (6) that is fully occupied by the fibrous material (MF), and a peripheral groove (7) of the same cavity (2) is maintained empty;
after the step of forming the composite positioned between mould (1) and counter-mould (3), the polymeric material (MP) covers the fibrous material (MF) in said central zone (6) of the cavity (2) and fills said peripheral groove (7) of the cavity (2) of the mould (1).

2. A moulding equipment for co-moulding a composite, comprising a mould (1) provided with a cavity (2) and a counter-mould (3) equipped with a counter-cavity (4), characterized in that the cavity (2) of the mould (1) has a projection (5) which divides the cavity (2) into a central area (6) and a peripheral groove (7).

3. The moulding equipment according to claim 2, wherein said projection (5) is continuous and the peripheral groove (7) is a perimeter groove which completely surrounds said central zone (6) of the cavity (2).

4. A heat-insulating and sound-absorbing product (P) made of a composite consisting of two distinct materials, the one being a fibrous material (MF) forming a first layer (10) having opposite bases (11, 12) and side faces (13), the other being a polymeric material (MP) forming a second layer (14) that is superimposed and welded to a base (11) of the opposite bases (11, 12) of the first layer (10), characterized in that said second layer (14) of polymeric material (MP) extends around said first layer (10) of fibrous material (MF) without any contact with the side faces (13) of said first layer (10) of fibrous material (MF).
